(19) United States
(12) Patent Application Publication
(10) Pub. No.: US 2016/0162825 A1
(43) Pub. Date: Jun. 9, 2016

(54) MONITORING THE IMPACT OF INFORMATION QUALITY ON BUSINESS APPLICATION COMPONENTS THROUGH AN IMPACT MAP TO DATA SOURCES

(71) Applicant: International Business Machines Corporation, Armonk, NY (US)

(72) Inventors: Asit DAN, Pleasantville, NY (US); Harald C. SMITH, Groveland, MA (US)

(21) Appl. No.: 14/831,748

(22) Filed: Aug. 20, 2015

Related U.S. Application Data
(63) Continuation of application No. 14/561,906, filed on Dec. 5, 2014.

(51) Int. Cl. G06Q 10/06

(52) U.S. Cl. CPC G06Q 10/06375; G06Q 10/067

(57) ABSTRACT

The present disclosure relates to building and maintaining an impact map for a plurality of business application components (BACs) operating in a computing environment. The impact map impact map identifies associations between the BACs operating in the computing environment and terms in the business glossary. The business glossary specifies terms used by the plurality of BACs. The impact map may be updated in response to changes in the computing environment, such as a BAC being added to the computing environment, a change in a stated use of a term by one of the BACs, and an update to a measure of importance of one of the terms to a BAC which uses that term, updating an impact map to reflect the indicated change.

### CROSS-REFERENCE TO RELATED APPLICATIONS

This application is a continuation of co-pending U.S. patent application Ser. No. 14/561,906, filed Dec. 5, 2014. The aforementioned related patent application is herein incorporated by reference in its entirety.

### BACKGROUND

The present disclosure relates to information management, and more specifically, to dynamically monitoring relationships between business application components and underlying data sources.

Software applications have been developed to assist virtually any aspect of business operations. Such software applications generally allow an enterprise to create, edit, use, and otherwise manage the data and information used by that enterprise. While business software applications originally operated in a generally independent manner relative to one another, advances in computing power and networking have allowed software applications to be developed which have any number of interacting components. For example, software applications, sometimes referred to as services, business processes, business rules, business objects, modules, components etc., can be integrated within an enterprise computing environment to share information and data across any number of software applications. Frequently, multiple software applications in such an environment may rely on a common set of terms or share access to data from common sources. Assume, e.g., in a computing environment used to manage product delivery of goods ordered from on online retailer, different computing applications may use terms relating to a street address, unit number, city, state/province, and postal code to process a given order. For example, software applications hosting the online store may receive orders from customers (via yet another application) along with addresses for both shipping and credit card billing. Information received from a customer for a given order is then accessed by other applications, e.g., inventory management applications, billing applications used to process and confirm payment, fulfillment applications used to fulfill an order, and shipping applications used to track an order through delivery.

In varying degrees, the performance of these applications often depends on the accuracy of data supplied by a user (e.g., the person entering an order), generated by the software applications processing data, or otherwise shared across different software applications.

Frequently, data quality issues related to data used by software applications to perform integrated computing tasks (e.g., applications which automate the selection of a warehouse from which an order should be fulfilled or which automate the printing of a shipping labels) are not be visible or available to system administrators or information technology (IT) professionals. Further, the impact a given term has on the performance of different software applications which use that term may not be readily apparent to end users of that process (e.g., an individual ordering goods online is unlikely to understand the impact that errors in an address supplied in online order will have on the variety of software applications used to process and manage that order).

Thus, while the importance of a given business term (and quality of data corresponding to that business term) may differ across a set of integrated software applications in an enterprise, system administers, IT professionals, and other users often lack a view which identifies the scope, use, and impact of business terms and data quality have across such applications. The lack of such insight means that changes to business terms in a business glossary, (e.g., changes resulting from changes government policy or changes to the business operations or goals) result in adverse impacts to business performance in the software applications that rely on such terms. For example, when a change is made to a business term in a business glossary, or changes are made to data values corresponding to a given term, there is no ability to understand the varying impact such changes may have across a set of software applications that process, or otherwise rely on, data corresponding to a business term.

### SUMMARY

One embodiment disclosed herein includes a method for dynamically generating and maintaining an impact map identifying associations between a plurality of business application components (BACs) operating in a computing environment and business terms in a business glossary. This method may generally include upon receiving an indication of a change to the computing environment, updating an impact map to reflect the indicated change. The change itself may indicate at least one of a BAC being added to the computing environment, a change in a stated use of a term by one of the BACs, and an update to a measure of importance of one of the terms to a BAC which uses that term.

In a particular embodiment, the business application components (BAC) include one or more executable applications, components, modules, processes, services, objects, functions, or business rules. Further, the measure of importance of one of the terms to a BAC which uses that term identifies at least one of a qualitative measure of impact the terms has on the BAC, a quantitative measure of impact the term has on one or more business performance indicators, and a textual description of an impact the term on performance of the BAC. Further, the method may also include defining a plurality of impact assessment rules. Each impact assessment rule specifies criteria for generating an alert based on at least one of the measure of importance of one of the terms in the business glossary to one of the BACs which use that term and a measure of data quality of data corresponding to a term in the business glossary being supplied to one of the BACs which use that term.

In a particular embodiment, this method may also include generating, from the updated impact map, a report evaluating at least one of an impact to one or more of the BACs of an observed measure of data quality of data corresponding to terms in the business glossary processed by the one or more of the BACs and changes to the observed measure of data quality of data corresponding to terms in the business glossary processed by the one or more of the BACs.

Another embodiment includes a computer program product comprising a computer-readable storage medium having computer readable program code embodied therewith, where the computer readable program code configured to perform an operation for dynamically generating and maintaining an impact map identifying associations between a plurality of business application components (BACs) operating in a computing environment and business terms in a business glossary. This operation may generally include, upon receiving an indication of a change to the computing environment, updating an impact map to reflect the indicated change. The change may indicate at least one of a BAC being added to the computing environment, a change in a stated use of a term by one of the BACs, and an update to a measure of importance of one of the terms to a BAC which uses that term.

Still another embodiment includes a system having a processor and a memory storing one or more supplications, which, when executed, perform an operation for dynamically generating and maintaining an impact map identifying associations between a plurality of business application components (BACs) operating in a computing environment and business terms in a business glossary. This operation may generally include, upon receiving an indication of a change to the computing environment, updating an impact map to reflect the indicated change. The change may indicate at least one of a BAC being added to the computing environment, a change in a stated use of a term by one of the BACs, and an update to a measure of importance of one of the terms to a BAC which uses that term.

### BRIEF DESCRIPTION OF THE SEVERAL VIEWS OF THE DRAWINGS

FIG. 1 illustrates an example of a networked computing environment, according to one embodiment.

FIG. 2 illustrates a block diagram of an example information quality management system, according to one embodiment.

FIG. 3 illustrates an example event monitor, according to one embodiment.

FIG. 4 illustrates an example information quality management system used to identify business application components and business glossary terms used within an enterprise computing infrastructure, according to one embodiment.

FIG. 5 illustrates a method for building an impact map identifying associations business application components and terms in a business glossary, according to one embodiment.

FIG. 6 illustrates a method for monitoring and updating an impact map, according to one embodiment.

FIG. 7 illustrates an example information quality management system that generates and dynamically modifies an impact map reflecting associations between a business application component and business terms used by the business application component, according to an embodiment.

### DETAILED DESCRIPTION

Embodiments presented herein describe techniques for dynamically building, maintaining, and using an impact map storing associations between a collection of enterprise software applications and business terms in a business glossary used by the applications. A business glossary generally provides a repository of business terms used by an enterprise. A business glossary may define a set of terms and can be browsed or searched by users to ensure they have the right understanding of a business term. A business glossary may also include additional metadata such as an owner, a steward, or examples of use, etc. Further, a business glossary can also include rules associated with a business term, such as requirements for information quality, data privacy, or lifecycle management.

In one embodiment, the impact map stores mappings between individual software applications and a business glossary. The impact map may be evaluated to understand the impact of business terms (as well as the impact of data quality) on the software applications used within an enterprise. More specifically, embodiments presented herein provide techniques to generate and dynamically update an impact map, which provides a mapping of business terms used by a software application, correlates terms with the frequency of various events (e.g., a decision, error, or user activity) to measure an impact a business term has on an application, and update mappings based changes to the applications, business glossary, or measures of importance. The mappings reflected in the impact map allows for the maintenance and monitoring of the impact of information quality on an integrated collection of software applications. Note, depending on context, the software applications identified in the impact map may be referred to herein as a business application component (BAC), an executable application, component, module, process, service, object, function, or rule, or more simply, just as an application or process. Additionally, for purposes of this disclosure, the term “data quality” generally refers to the accuracy, completeness, and correctness of format of data.

In one embodiment, an information quality management system includes a business process engine and an information management engine. The business process engine may run a variety of business application components. A mapping subsystem may receive mappings between business application components and terms in a business glossary. As noted, a business glossary may define a variety of terms and metadata related to the terms. Business glossaries may differ depending on the business application component associated with the glossary. For example, in a package shipment application, a business glossary may define terms for postal address, e.g., an address, city, state/province, and postal code. In contrast, in an insurance claim processing system, a business glossary may define terms related to diagnosis codes and reimbursement, e.g., claim numbers, policy IDs group IDs treatment codes, member information, etc.

In one embodiment, an information management engine may receive input related to a business application component. Inputs may include, for example, events, such as a success or failure of an operation, decisions, or user activity, or reports relating to business application component events (e.g., over a period of time). In one embodiment, the information management engine may also receive input indicating a change to an enterprise computing environment. For example, the change could indicate a business application component being added or removed to the enterprise computing environment, a change in a the use of a term by one of the business application components, and an update to a stated importance of importance of a term to a given business application component.

The information management engine processes information relating to these events and/or reports to update the associations between business application components, terms in the business glossary and to update the importance of a term to a business application component in the impact map. Further, based on monitored events, the information management engine may determine that errors related to a particular term may have a greater impact on the success or failure of a process than errors in other terms—in such a case, the information management engine may update the stated importance of the particular term to the corresponding business application component in the impact map. The information management engine can use such a determination to, for example, trigger a search for higher quality sources of data or inform a user, via a user interface, that low information quality for the particular term may constitute a point of failure in a business process.

Advantageously, applying mapping and monitoring techniques to build an impact map reflecting how terms (and data quality) impact the performance of the business application components in an enterprise allows system administrators and IT professionals to more effectively and efficiently manage a collection of software applications, data sources, and business glossaries used by an enterprise. Over time, the information quality management system can observe the scope of usage of business application components and data sources, identify and monitor the impact of changing data quality on a business process, as well as trigger the identification of information quality measures that may be taken to improve information quality.

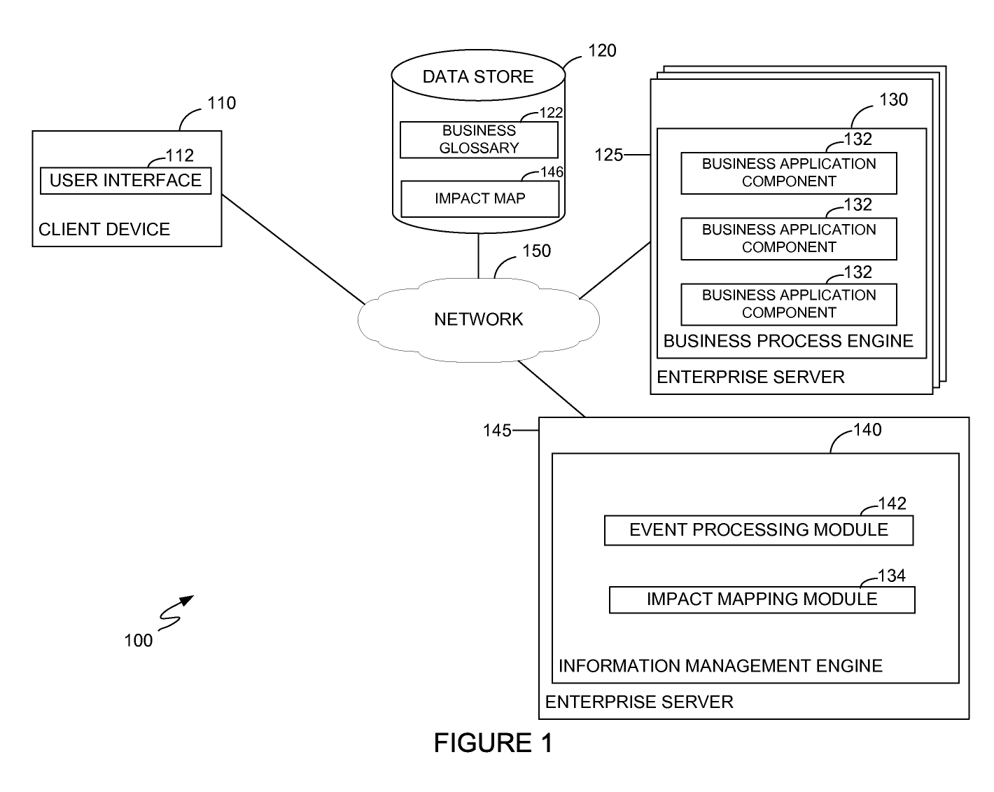

FIG. 1 illustrates an example computing environment 100, according to one embodiment. As shown, the computing environment includes a client device 110, a data store 120, enterprise server systems 125, which include a business process engine 130, and an enterprise server 145, which includes an information management engine 140. As shown, client device 110, data store 120, business process engine 130, and information management engine 140 are connected to network 150. For example, network 150 may include the Internet, an intranet, a local area network, etc. The enterprise servers 125 may provide computing resources used to host business process engines 130 used to provide the business application components 132 for a given enterprise.

Client device 110 may be a personal computer, workstation, mobile device, or any other computing device able to access network 150. Further, client device 110 may include a user interface 112 which displays information from business process engine 130, information management engine 140, or other sources stored locally on client device 110 or on devices connected to network 150. User interface 112 may include, a user interface rendered on a web browser which can access web pages hosted on servers connected to network 150 (e.g., in a distributed system, servers hosting business process engine 130 and/or information management engine 140). Business process engines 130 may be any framework or platform used to host and execute the business application components 132. For example, the business process engines 130 could include web server, application server, and database systems used to provide an online retail service. As another example, business process engines 130 could provide application servers, frameworks, or platforms used to support the online service. For example, in context of an online retail website, business process engines 130 could include business application components 132 deployed to provide the online website, along with components 132 for ordering, payment processing, inventory, fulfillment services, addressing and shipping services, invoicing and auditing services, data warehousing services, etc. In addition, business process engine 130 can itself be a business application component 132, such as a standalone software application integrated with other systems. Of course, the particular servers 125, process engines 130, application components 132 and integration among such systems may be tailored to suit the needs of a particular case.

Data store 120 may contain information accessed by client device 110, business process engine 130, information management engine 140, and other devices connected to network 150. Data store 120 may store, for example, business glossary 122, or other data that may be used or generated by business process engine 130 and/or information management engine 140. As noted, a business glossary 122 may provides a repository of business terms used by the business application components 132. A business glossary 122 may define a set of terms and can be browsed or searched by users to ensure they have the right understanding of a term. A business glossary 122 may also include additional metadata such as an owner, a steward, or examples of use, etc. Further, a business glossary 122 can also include rules associated with a term, such as requirements for information quality, data privacy, or lifecycle management.

As shown, business process engine 130 includes one or more business application components 132. As noted, each business application component 132 may provide a software component used to perform a set of computing tasks needed by an enterprise. Again, using online commerce as an example, a user may interact with a first business application component 132 (e.g., a web server) to place an order for goods and to provide payment and shipping information. In turn, the first business application component 132 may then interact with a variety of other business application components 132 (application servers, database systems, web services, etc.) to confirm payment, update financial records, as well as cause a shipment to be made (e.g., generating a packing label and scheduling pickup and/or delivery of the shipment).

In one embodiment, the information management engine 140 may be configured to build an impact map 146 to receive, store, update, and evaluate relationships between terms in a business glossary 122 and a collection of business application components 132 that use the terms. As shown, information management engine 140 includes an impact mapping module 134, an event processing module 142, and an impact map 146.

The impact mapping module 134 (or just “mapper”) may receive information identifying the business application components 132 deployed by an enterprise and which terms (from business glossary 122) used by that business application component 132. For example, an IT professional or data steward may build a business glossary 122 appropriate for a given enterprise, as well as identify which business application components 132 (or other software applications) use a given term. The mapper 134 may also receive information identifying a measure of importance a given term has to the success or failure of data processing tasks performed by a corresponding business application component 132. For example, the measure of importance to a business application component of a term may specify a declared measure of importance (e.g., “high,” “low,” “critical,” etc.). That is, the measure of importance may be stated a qualitative measure of impact the terms has on the business application component. Similarly, the measure importance could also identify an impact data quality of that term may have one or more key performance indicators associated with the business application component. That is, the measure of importance may be specified as a quantitative measure of impact the term has on one or more business performance indicators, e.g., a measure of revenue loss per day per failure instance. Term importance could also be specified relative in terms of the consequences of data processing actions performed by the business application component (e.g., an indication of whether a term is required by the business application component or what processes will fail (or cannot occur) if the value of a given term is not supplied, incorrect, incomplete, etc. That is, term importance could provide a textual description of an impact the term on performance of the business application component.

In one embodiment, information received by the mapper 134 may be stored in the impact map 146. That is, the impact map 146 may store information indicating what terms are used by a given business application component 132 as well as a stated measure of importance a given term has on the performance of that business application component 132. More generally, the impact map 146 may store a variety of information used to identify, monitor, and update the impact information data quality on business application components. Such information may include, for example, information related to events (e.g., outcomes of a process based on various data inputs), activities (e.g., what task(s) the business process is configured to perform), subsidiary steps, criticality of a process, the impact of errors and data that may cause the business process to generate an error, a process owner, or other information about the process (e.g., software artifacts or annotations).

Information received by the mapper 134 may be used to generate a mapping in the impact map 146. The mapping may reflect a relationship between a business application component 132 and a term in the business glossary 122. Mappings in the impact map 146 may be defined by an IT professional, data steward, or other enterprise personnel. In some embodiments, such mappings may also be generated automatically. For example, the mapper 134 may apply text analysis, parsing, term retrieval, probabilistic and deterministic matching and linking of words, word groups, and relationships, dynamic weighting and costing of a map based on configuration criteria, or other techniques to automatically generate mappings between business application components 132 and terms in the glossary 122. In some embodiments, mapper 134 may present candidate mappings to an IT professional (or other user) for acceptance or refinement.

In addition to identifying terms from the glossary 122 are used by the business application components 132, the impact map 146 may also include rules for evaluating changes to the impact map 146 as well for evaluating other events. For example, an impact assessment rule may specify criteria, conditions, triggers, thresholds, etc., for generating an alert based on the importance a term has to a business application component 132 or based on changes in data quality of data received by a business application component 132. The criteria may be based on a variety of measures, including linked key performance indicators (KPIs), cost attributes, frequency of links from processes to terms, number of links from terms to other processes and activities, number of related process steps and events, or a number of associated users or data artifacts.

For example, the event processing module 142 may receive information identifying changes to a computing environment hosting the business application components 132. In response, the event processing module 142 could update the impact map 146 as well as evaluate the updated impact map 146 against a set of impact assessment rules. For example, an IT professional, data steward, etc., could provide information to update the mappings of the impact map 146. Such a change could include, e.g., introducing a business application component 132 to the environment, removing a business application component 132 from the environment, modifying one or more of the terms in the business glossary 122 used by one of the business application components 132, modifying the terms used by a business application component 132, or changing the stated measure of importance of a term to a given business application component 132. As noted, such a measure of importance may take a variety of forms, including a quantitative level of importance (“high,” “low,” etc.), a qualitative level of importance, i.e., a consequence a term has on processing or outcomes such as a monetary cost, time delay or other consequences that flow from a definition or a change in a definition, or anticipated impact a term has on key performance indicators. Such a measure of importance may also provide a textual description of a textual description of an impact data corresponding to a business term from the glossary has on the performance of the business application component.

In one embodiment, the event processing module 142 may also monitor business application components 132 for a set of specified events and to, over time, update or specify the measure of importance a term has to a business application component 132 (as reflected in the impact map 146) as well as update the associations in the impact map between a business application component and a term in the business glossary. Further, as noted, when changes to the impact map 146 occur, impact assessment rules may be evaluated to determine whether an alert should be generated or an IT professional (or other user) should be notified.

Similarly, events monitored by the event processing module 142 may be used to determine a measure of data quality for data supplied to a given business application component 132. Such data may correspond to a term in the business glossary used by that business application component 132. Using a shipping application as an example, one event could include a message from a shipping application that a package was undeliverable. Such a failure may be associated with a cost (e.g., a cost to re-ship the package after contacting a customer to request a corrected delivery address) or how long package delivery is delayed. The event processing module could measure data quality for the shipping application based on a cumulative cost of re-shipping packages over a time window or an average that incorrect data delays a delivery past a projected delivery date. In one embodiment, should the data quality (e.g., a cumulative cost on shipping resulting from address errors) exceed a threshold (or satisfy other criteria), then the event processing module 142 could generate an alert sent to a IT professional (or other user) responsible for business application components 132. Such an alert might be limited to business application components indicated in the impact map, has having a “high” measure of importance for address terms. That is, if the event processing module 142 determines that a change in observed data quality related to a term used by a business application component 142 satisfies an impact assessment rule (e.g., because observed data quality has degraded below a threshold), then alerts could be generated for business application components 132 which both use that term and have a stated measure of importance indicating a high dependence on that term. More generally, the impact assessment rules may include data characterizing information quality, the impact of poor information quality (i.e., invalid data) on a business application component 132 and thresholds for when an alert prompting remedial action relative to a given business application component 132 or term should be issued.

In one embodiment, event processing module 142 may also monitor the impact of events, e.g., by evaluating an aggregate impact of events against other measures of performance, such as key performance indicator (KPI) metrics. For example, events may be defined, such as error events, manual events or overrides (e.g., where a user manually inputs data to perform a business process), or additional data requests. A value associated with an event may specify how each occurrence of an event should contributes to a cumulative impact or cost of poor data quality for a particular term and/or business application component 132. Once the value of the cumulative impact for a particular term and/or business application component 132 satisfies an impact assessment rule, event processing module 142 may generate an alert presented to a user. Further, additional analysis may be performed in event processing module 142. For example, event processing module 142 may correlate errors or exceptions reported by the business application components 132 with information quality measurements or correlate the frequency of errors or exceptions with the cost and impact of those errors. Of course, events monitored by the event processing module 142, the criteria for determining (or changing) a current data quality of data supplied to a business application component 132, and the criteria for changing a measure of importance of a term in the impact map may all be tailored for the needs in a particular case.

In one embodiment, the event processing module 140 may be configured to suggest changes to data sources used to supply data (for terms in the business glossary 122) to a given business application component 132, e.g., based on changes in observed data quality of data for a given term. For example, once impact and information data quality events satisfy a threshold for an impact assessment rule, the event processing module 142 could search for an alternative data source for data corresponding to a term used by a business application component 132 specified in that rule. Alternatively, the event processing module 142 could change which terms are used by that business application component 132. For example, in some embodiments, a given business application component 132 may be configured to search for alternative data sources having similar required characteristics as the data required for the business application component 132. Automated searching for alternative data sources may use techniques such as duplicate identification and probabilistic matching to identify potential alternative data sources based on, for example, a calculated confidence score. For example, in a package shipment application, alternative data sources may include databases with name and address information used in place of (or to augment) address information provided by a user. In some cases, the confidence score for an alternative data source may be generated by using a sample of data from the alternative source in the business application component 132. In some embodiments, the application component 132 may prompt an IT professional, data steward (or other user) to search for or provide to an alternative data source for a business application component 132.

As noted, in some cases, the decision to search for or recommend an alternative data source may be related to the measure of importance of a term in the business glossary to a business application score, and a measure of the cumulative impact of errors in data corresponding to that term (or other measures of data quality). In some cases, the cumulative impact for a particular term and/or process may be calculated based on a running window. Older events, which may have prompted an update to a data source selection or otherwise changed a mapping and/or measurement attribute, may contribute to a cumulative impact for a limited amount of time.

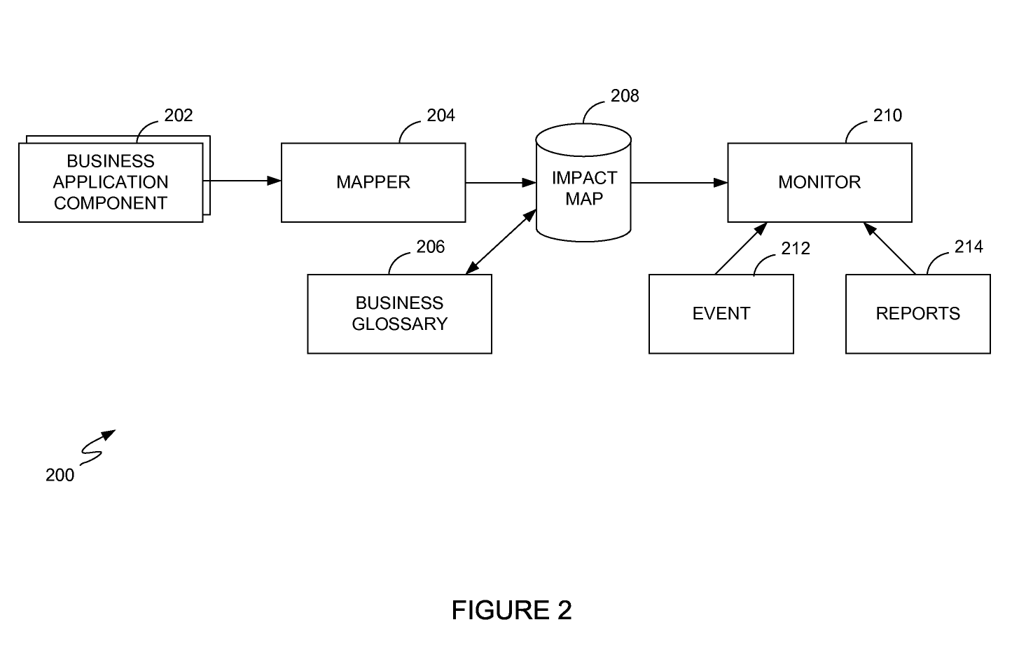

FIG. 2 illustrates a block diagram of an example information quality management system 200 according to some embodiments. As shown, information quality management system 200 includes a business application component 202, a mapper 204, a business glossary 206, an impact map 208, a monitor 210, event data 212, and report data 214. Information regarding a business application component 202 may be used in conjunction with mapper 204 to create mappings between business application component 202 and terms in a business glossary, i.e., to create an impact map 208. The mappings may be stored in impact map 208. Based on the mappings stored in impact map 208, monitor 210 may receive event data 212 and/or report 214 to determine the occurrence of an event and the impact of that event on information quality relative to impact assessment rules. As discussed above, event data 212 may include an indication of the success or failure of a process for a data input, changes to business terms for a business application component 202, changes in importance of terms from the business glossary 208 used by a business application component 202, and so on.

Report data 214 may correlate impact events used to measure data quality to terms in the business glossary and, over time, to an importance of that term to business application components 202 using that term. For example, in one embodiment, a report may evaluate the mappings between business application components 202 and terms in the business glossary 208, along with the measure of importance assigned to terms for a business application component 202, to identify an impact to one or more of the BACs of an observed measure of data quality of data corresponding to terms in the business glossary processed by the one or more of the BACs. Such a report could also identify an impact changes to the observed measure of data quality of data corresponding to terms in the business glossary processed by the one or more of the BACs. More generally, monitor 210 may generating a report indicating am impact data quality of data for terms from the business glossary on the business application components 202 and indicating which components may be vulnerable or at risk to changes in data quality. Monitor 210 may also determine whether a given event should result (or contribute to) a change in a current measure of data quality for data corresponding to terms in a business glossary 208.

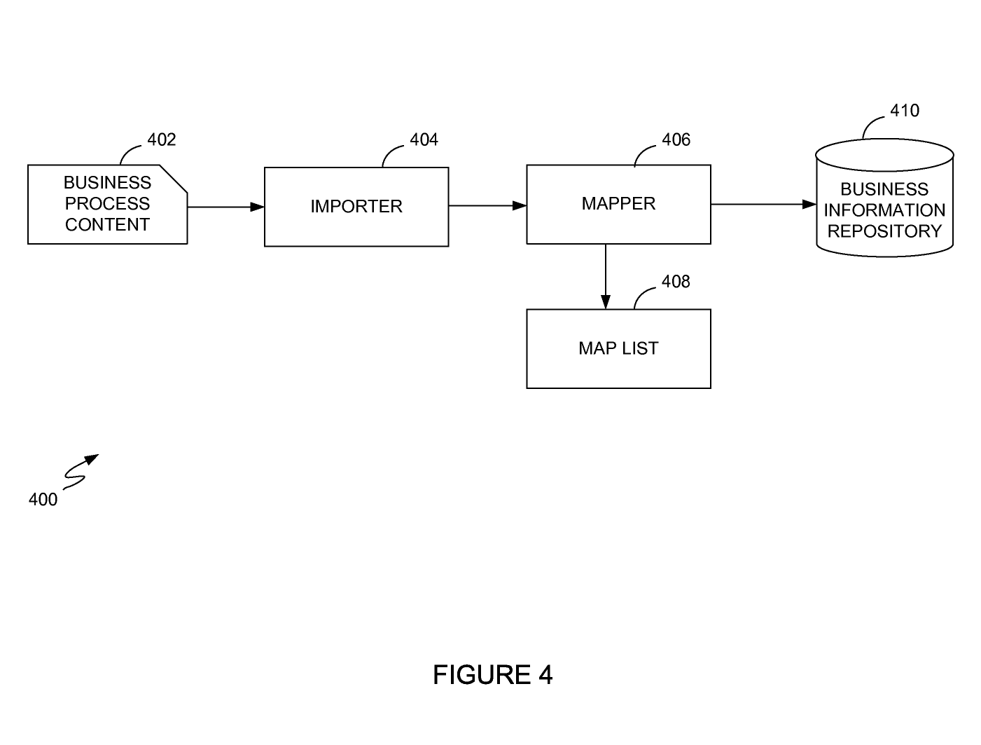

As discussed above, mappings between business application component 202 and a term in business glossary may be received from an IT professional, data steward (or other user) as well as derived by evaluating inputs to a business application component 202 text analysis, parsing, term retrieval, probabilistic and deterministic matching and linking of words, word groups, and relationships, dynamic weighting and costing of a map based on configuration criteria, or other techniques to identify mappings between terms in the business glossary to the business application components 202. For example, FIG. 4 discussed below, illustrates an example of identifying business application components and terms using standardized markup grammars for describing business processes.

As noted, the monitor 210 may be configured to observe (or receive notification of) events that may affect data quality for terms in the business glossary 208. For such monitoring, the monitor 210 may determine which business application components 202 use a term, as well as evaluate whether observed changes in data quality should result in an alert, based on the measure of importance for that term identified in the impact map 206 and the observed change in data quality. The monitor 210 may also monitor which business application components 202 have a mapping to a given term, the number of associated terms, as well as monitor how data quality for terms used by a business application component 202 impacts key performance indicators. As events occur that change (or contribute to changes) in data quality, if such changes (or contributions) satisfy impact assessment rules, an alert may be generated. For example, when data quality for a term has a state that will result in a key performance indicator falling below a minimum threshold, an alert may be generated.

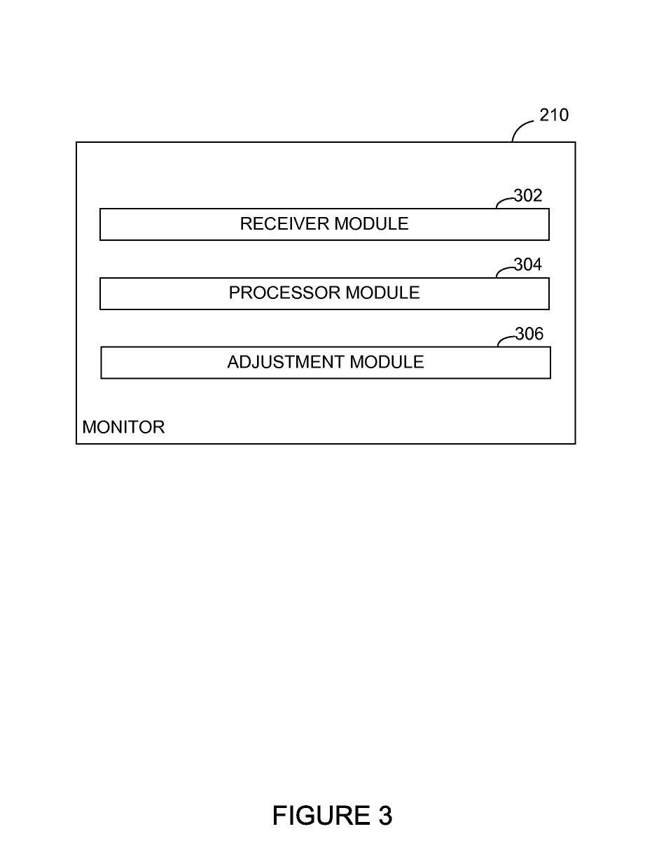

FIG. 3 shows an example monitor 210, according to one embodiment. In some cases, monitor 210 may perform functions described relative to the event processing module 142, illustrated in FIG. 1. As shown, monitor 210 includes a receiver module 302, a processor module 304, and an adjustment module 306. Receiver module 302 may receive events 212 and/or reports 214 as input to be processed by processor module 304. The events may specify changes to the impact map 208, such as changes to the business application components in a computing environment, changes to which terms from the business glossary are used by a business application component, or changes to a measure of importance a term in the business glossary has for a business application component which uses that term. In addition to changes in the impact map itself, other events may be related to measures of data quality for data corresponding to terms in the business glossary, whether for data consumed by a business application component or generated by a business application component.

For changes that update impact map, the processor module 304 may evaluate impact assessment rules to determine whether the relationships between the application components, terms, and importance of such terms, in the updated impact map should result in an alert. For example, changes to a term in the business glossary may trigger an impact assessment rule for a business application component that uses that term, and which have a high stated measure of importance for that term.

For changes in observed measures of data quality, processor module 304 may process the received event or report and determine whether the impact of changes in data quality on the business application components should result in an alert. For example, if the impact from an event 212 or report 214 causes a cumulative impact to exceed a threshold value, adjustment module 306 may recommend changes to the terms used by a business application component or changes to a source of data used to supply data for a term (e.g., if alternatives are available in the business glossary).

Similarly, a cumulative effect of events occurring at a business application component (relative to a term used by that component) may result in changes to a measure of importance between that business application component and that term, as specified in the impact map. That is, the adjustment module 306 could increase (or recommend an increase) to the stated measure of importance on a term to a business application component in the impact map. For example, if the cumulative impact of events resulting from poor quality for that term, when processed by the business application component, results in a substantial decrease in a key performance indicator, then the importance of that term to the business application component may be increased (e.g., when a cumulative measure of costs for reshipping packages based on poor data quality of address terms printed in shipping labels exceeds a specified threshold over a given time period). As noted, the definition of an event, the impact (or contribution) to an observed measure of data quality, the specific changes in quality, as well as the thresholds, criteria, alternative recommendations for term use or data sources, etc., may be specified in a set of impact assessment rules tailored to the particular application business application components, business glossary, and information and data processing needs of a given enterprise.

In one embodiment, monitor 210 may include predictive analytics or simulated cognitive process modules, which may be used to determine a measure of importance for events monitored by monitor 210. Similarly, the monitor 210 may use predictive analytics to determine events that correlate to changes in data quality. In some cases, the predictive analytics may assess data corresponding to terms from the business glossary that are supplied to business application components and generate feedback (e.g., generating an event to be recorded and processed by monitor 210 to prompt a modification of a mapping and/or measurement attribute or a choice of data source for the a given business application component). In some cases, the predictive analytics may test alternative data sources to determine if an event occurs and the impact of such an event. Based on testing of alternative data sources, the predictive analytics may determine whether an alternative data source can improve data quality for a given term, and thus, whether switching to the alternative data source should be recommended.

FIG. 4 illustrates an example information quality management system 400 used to identify business application components and candidate business glossary terms used within an enterprise computing infrastructure, according to one embodiment. As noted above a business application component can refer to any software application, component, module, function, or program executed on a computing system. In one embodiment, business application components may be specified using standardized markup grammars. That is, business process content 402 may include markup language descriptions of business processes or actions performed by a set of software applications. For example, business processes may be described using a Business Process Model and Notation (BPMN) specification, Business Process Execution Language (BPEL), according to an XML schema, a service registry, a database table, or other appropriate file format or notation schema. Business process content 402 may be imported into system 400 via importer 404, which may be configured to read a directory of relevant content files or tables, compare the files or tables to existing content, parse the content of markup language descriptions and identify one or more business application components used to implement a process described by a BPEL document (or described using another standardized description language). In one embodiment, the mapper 406 may generate a list of business application components associated with a business process along with mappings to terms in a business glossary. For example, the business application components identified from the process content 402 may be provided to a mapper 406. Mapper 406 may read a set of business terms, parse content for existing and possible terms based on a map list 408, identify and remove duplicate content, identify the frequency of an occurrence of an object associated with a specific activity, and create impact maps stored in business information repository 410.

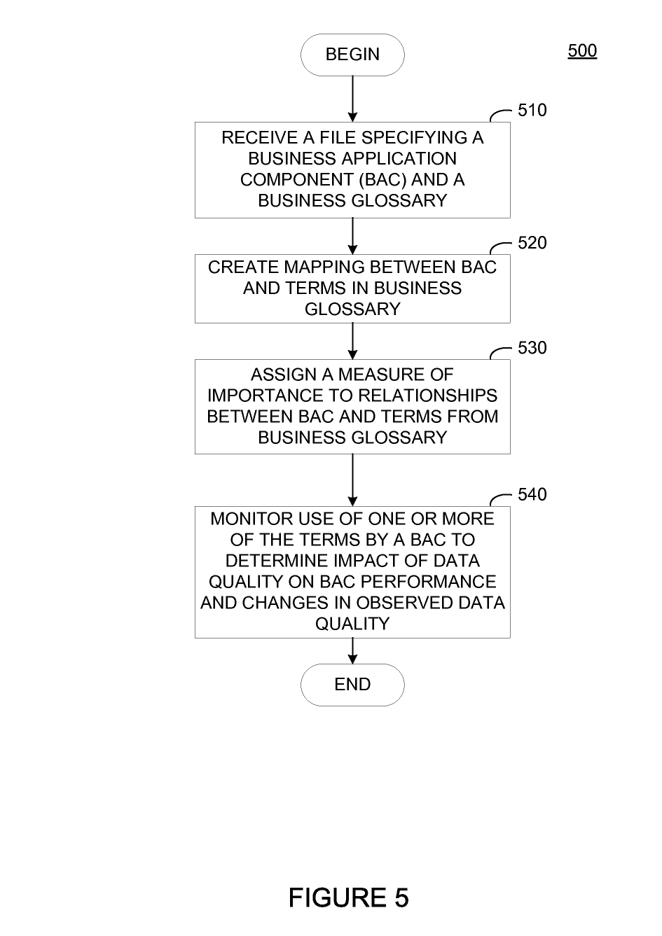

FIG. 5 illustrates a method 500 for building an impact map identifying associations between business application components and terms in a business glossary, according to one embodiment. As shown, method 500 begins at 510, where an information quality management system receives a file identifying one or more business application components and a business glossary of terms used by such components. For example, the information quality management system may receive a markup language document describing a package shipment application and a business glossary identifying terms used by the package shipment application (e.g., address, city, state/province, postal code, and so on). As noted, the package shipment application may be one component integrated with others and sharing a common business glossary. For example, the package shipment application may rely on information provided by a consumer interacting with another business application component, which provides an online website. Other business application components in such a computing environment could include payment processing applications used to process and confirm payment for an order placed by a consumer, invoicing and accounting components used to track revenue, inventory application components, fulfillment applications used to manage order fulfillment, a customer support application used to manage feedback and orders from client, etc.

At step 520, the information quality management system creates a mapping between each business application component and terms in the business glossary. As described, a mapping may describe relationships between a given business application component and specific business terms in the business glossary used by that business application component.

At step 530, the information quality management system assigns measure of importance a given business application component has on given term from the business glossary. In one embodiment, the measure of importance may be supplied as part of the description of the business application component. As noted, the measure of importance may identify a declared measure of importance (e.g., “high,” “low,” “critical,” etc.) on a term. Importance could also be specified relative to costs or consequences of data processing actions performed by the business application component (e.g., an indication of whether a term is required by the business application component or what processes will fail (or cannot occur) if the value of a given term is not supplied, incorrect, incomplete, etc. Similarly, the measure of importance could also identify an impact data quality of that term may have one or more key performance indicators associated with the business application component.

In addition, the file received at step 510 may include one or more impact assessment rules used to evaluate whether changes in the impact map or changes in data quality corresponding to such terms should result in alerts. Similarly, the impact map may also specify which events should be monitored by an event monitor, as well as how an occurrence of an event should result in changes (or contribute to changes) in measurements of data quality. Additionally, impact assessment rules may also specify when changes in data quality for a data of a given term should result in an alert for the business application component. For example, a impact assessment rule may specify a need for data associated with one of the business terms, revenue changes resulting from changes in data associated with one of the business terms, a cost incurred where the system lacks data associated with a business term, or a cost incurred from the degradation of data quality associated with a business term. The information recited at steps 510, 520, and 530 may be stored in an impact map, as described above.

At 540, the information quality management system monitors the use of terms by a business application component, both to monitor data quality of data provided to the business application components. Based on the monitored performance, the information quality management system can dynamically modify the mapping and the measures of importance in the impact map, based on processing events performed by the business application component. That is, the information quality management system may determine that the measure of data quality for a particular term should be increased (e.g., if data associated with the term is causing repeated process failures), reorder the importance of terms, or otherwise take action, such as a modify (or recommend a modification) to a data source used by a business application component, in an attempt to reduce the number of process failures. Using a package shipment application as an example, if invalid or incorrect data for a postal code repeatedly causes a failure to successfully deliver (or dispatch) packages, the information quality management system can increase the required data quality (e.g., formatting, correct association with other address information) and can also increase the impact of incorrect data on the process (e.g., using a multiplier to amplify impact from a base amount).

Additionally, in one embodiment, associations between a business application and a term in the business glossary in an impact map may be updated by IT professionals, data stewards (or other users) as changes are made to a computing environment hosting the business application components identified in the impact map. In one embodiment, the monitoring of step 540 may include updating the impact map based on information from a user and evaluating the updated map against the impact assessment rules.

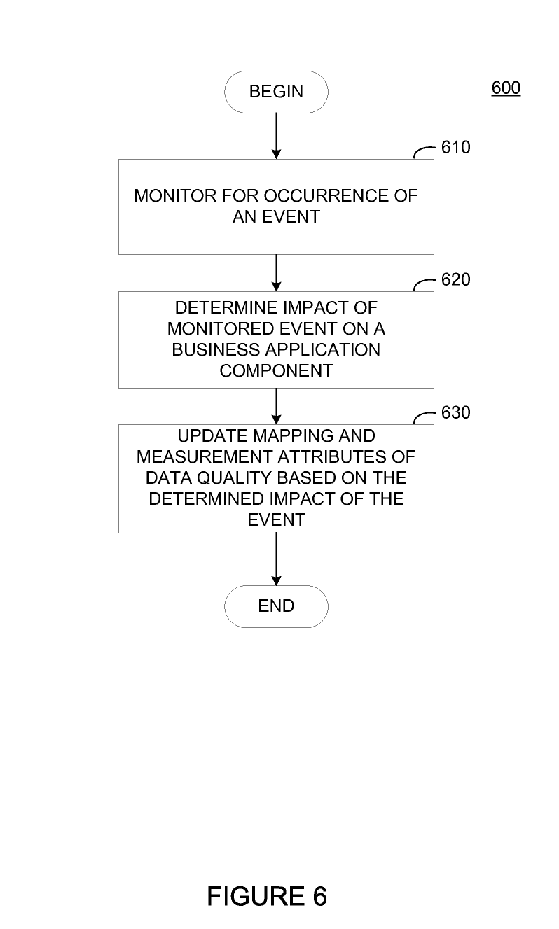

FIG. 6 illustrates a method 600 for monitoring and updating an impact map, according to one embodiment. As shown, method 600 begins at 610, where an information quality management system monitors for an occurrence of an event. Taking a package shipment application as an example, the occurrence of an event may entail a shipment failure, an address verification error, and so on. At 620, the system can determine an impact of an occurrence of one of the monitored events to a business application component. At 630, the information quality management system can update a mapping and measure of observed data quality based on the determined impact of the event. For example, as discussed above, an update to mapping and measurement attributes may be performed once a cumulative impact over a period of time exceeds a threshold value, but need not be performed if the running cumulative impact falls below the threshold value.

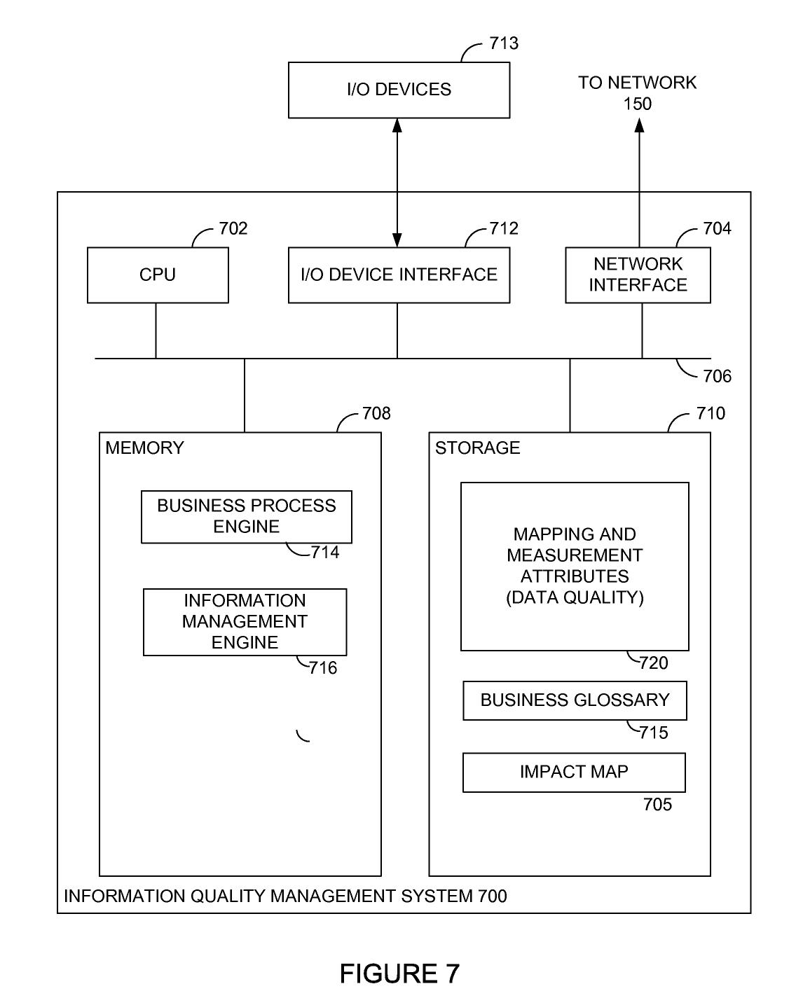

FIG. 7 illustrates an example information quality management system 700 that generates and dynamically modifies an impact map reflecting associations between a business application component and business terms used by the business application component, according to an embodiment. As shown, the information quality management system 700 includes, without limitation, a central processing unit (CPU) 702, a network interface 704, an interconnect (i.e., a bus) 706, a memory 708, and storage 710. Information quality management system may additionally include one or more I/O device interfaces 712 which may allow for the connection of various I/O devices 713 (e.g., keyboard, display, and mouse devices) to the information quality management system 700.

CPU 702 may retrieve and execute programming instructions stored in the memory 708. Similarly, the CPU 702 may retrieve and store application data residing in the memory 708. The interconnect 706 may facilitate transmission, such as of programming instructions and application data, among the CPU 702, I/O device interface 712, storage 710, network interface 704, and memory 708. CPU 702 is included to be representative of a single CPU, multiple CPUs, a single CPU having multiple processing cores, and the like. Additionally, the memory 708 is included to be representative of a random access memory. Furthermore, the storage 710 may be a disk drive. Although shown as a single unit, the storage 710 may be a combination of fixed and/or removable storage devices, such as fixed disc drives, floppy disc drives, tape drives, removable memory cards or optical storage, network attached storage (NAS), or a storage area-network (SAN).

As shown, the memory 708 includes a business process engine 714 and an information management engine 716. The storage 710 includes a mapping and measurement attributes 720, impact map 705, and business glossary 715. As discussed above, the business process engine 714 may provide a platform or framework hosting a collection of integrated business application components, which use terms from business glossary 715. And the information management engine 716 may create and dynamically update an impact map 705 based on updates received from IT professionals, data stewards, or other users, as well as based on monitored events.

As described above, the impact map 705 may store mappings between individual software applications (i.e., the business application components) and terms in a business glossary 715. Changes to the impact map 705 may be evaluated to generate alerts based on changes to the business application components deployed to a computing environment, changes in terms used by a business application component, changes in terms in the business glossary, changes to the importance of a term to a given business application component, etc. Further, observations of data quality, or cumulative impact of data quality, as reflected in mapping and measurement attributes 720, may be evaluated against impact assessment rules to determine when a change in data quality corresponding to a term in the business glossary should result in an alert. Such an alert may indicate an observed decrease in data quality for data falls below a threshold (or other criteria) for data supplied to a business application component with a high measure of importance on that data, may recommend changes to terms or data sources for a business application component, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the information quality management system components) or related data available in the cloud. For example, the business process engine (running a business application component) and information management engine could execute on a computing system in the cloud and generate mappings and measurement attributes between business application components and one or more business terms and modify the mappings and measurement attributes based on events recorded by the business application component. In such a case, the information quality management system could generate and update mappings and measurement attributes for a business application component or business process and store an indication of the mapping and measurement attributes at a storage location in the cloud. Doing so allows a user to access this information from any computing system attached to a network connected to the cloud (e.g., the Internet).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method for dynamically generating and maintaining an impact map identifying associations between a plurality of business application components (BACs) operating in a computing environment and business terms in a business glossary, the method comprising:
upon receiving an indication of a change to the computing environment, the change indicating at least one of (i) a BAC being added to the computing environment, (ii) a change in a stated use of a term by one of the BACs, and (iii) an update to a measure of importance of one of the terms to a BAC which uses that term, updating an impact map to reflect the indicated change.

2. The method of claim 1, wherein the business application components (BAC) include one or more of an executable application, component, module, process, service, object, function, and rule.

3. The method of claim 1, wherein the measure of importance of one of the terms to a BAC which uses that term identifies at least one of (i) a qualitative measure of impact the terms has on the BAC, (ii) a quantitative measure of impact the term has on one or more business performance indicators, and (iii), a textual description of an impact the term on performance of the BAC.

4. The method of claim 1, further comprising:
defining a plurality of impact assessment rules, wherein each impact assessment rule specifies criteria for generating an alert based on at least one of (i) the measure of importance of one of the terms in the business glossary to one of the BACs which use that term and (ii) a measure of data quality of data corresponding to a term in the business glossary being supplied to one of the BACs which use that term.

5. The method of claim 4, further comprising:
upon determining, from the updated impact map, that the criteria for at least a first one of the impact assessment rules has been satisfied, generating an alert identifying one or more of the BACs and one or more terms in the business glossary associated with the first impact assessment rule.

6. The method of claim 4, wherein the measure of data quality for at least one a first one of the impact assessment rules is based on an impact of an individual failure of one of the BACs and a cumulative impact of failures to that BAC over a period of time.

7. The method of claim 4, wherein the criteria for the first impact assessment rule specifies a minimum data quality requirement for data supplied to a first one of the BACs, and wherein the method further comprises;
in response to determining that data supplied to the first BAC from a current data source does not meet the minimum data quality requirement specified by the first impact assessment rule:
identifying, at least one alternative data source corresponding to the term in the business glossary which is available to supply data to the first BAC, and
generating an alert suggesting the first BAC be configured to use data from the alternative data source.

8. The method of claim 1, further comprising:
generating, from the updated impact map, a report evaluating at least one of (i) an impact to one or more of the BACs of an observed measure of data quality of data corresponding to terms in the business glossary processed by the one or more of the BACs and (ii) changes to the observed measure of data quality of data corresponding to terms in the business glossary processed by the one or more of the BACs.

9. The method of claim 8, wherein the report indicates that at least a first one of the BACs is vulnerable
to changes in the data quality of data corresponding to at least one of the terms in the business glossary.

10. The method of claim 1, wherein the associations identified in the impact map specify which terms, from the business glossary, are used by a given one of the BACs along with the stated importance of the terms from the business glossary used by the given one of the BACs
